(19) United States
(12) Patent Application Publication
(10) Pub. No.: US 2018/0059494 A1
(43) Pub. Date: Mar. 1, 2018

(54) LIQUID CRYSTAL DISPLAY PANEL AND MANUFACTURING METHOD FOR THE SAME

(71) Applicant: SHENZHEN CHINA STAR OPTOELECTRONICS TECHNOLOGY CO. , LTD., GUANGDONG (CN)

(72) Inventor: Sikun HAO, Guangdong (CN)

(21) Appl. No.: 15/318,364

(22) PCT Filed: Jun. 3, 2016
(86) PCT No.: PCT/CN2016/084737

§ 371 Date: Dec. 13, 2016

(30) Foreign Application Priority Data
Jan. 11, 2016 (CN) 201610017053.3

(51) Int. Cl. G02F 1/1362; G02F 1/1333; G02F 1/1368

(52) U.S. Cl. CPC G02F 1/136209; G02F 1/136286; G02F 2001/136222; G02F 1/1368; G02F 2201/121; G02F 1/133345

(57) ABSTRACT

An LCD panel and manufacturing method thereof are provided. The LCD panel includes a substrate, a device layer disposed on the substrate, a data line disposed on the surface of the device layer, and an organic insulating layer disposed on the surface of the device layer and/or the surface of the data line. The organic insulating layer has a groove corresponding to the data line. A black matrix is disposed in the groove. The surface of the black matrix and the surface of the organic insulating layer are on the same plane. The present invention has the following advantages. A convex structure formed by the black matrix on a glass substrate is removed to prevent a poor LC alignment caused by the convex structure. The mask of the black matrix is saved, thus the number of masks for production use is reduced, and a simple manufacturing process is provided.

### BACKGROUND OF THE INVENTION

### 1. Field of the Invention

The present invention relates to a field of liquid crystal display (LCD) panels, and more specifically to an LCD panel and manufacturing method thereof.

### 2. Description of the Prior Art

An LCD is the most widely used flat panel display, and has gradually become a display widely used in various electronic devices such as a mobile phone, a personal digital assistant (PDA), a digital camera, a computer screen, or a laptop screen. The display has a high-resolution color screen. With the development of liquid crystal display technology, people's requirements for the display quality, the exterior designs, and the like of LCDs are higher and higher.

With people's requirements for the display quality of the LCDs being higher and higher, BOA (Black Matrix on Array) technology has been paid more and more attention. The liquid crystal cell of a traditional LCD is constituted by three parts: an array substrate, a liquid crystal layer, and a color filter (CF) substrate. There is a panel driving circuit on the array substrate. There are a black matrix, a color filter, and a photo spacer on the color filter substrate. In the BOA technology, a color filter is formed on an array substrate. Defects such as the reduction of transmittance, the color shift of large viewing angle, and the like can be decreased by the technology. The reduction of transmittance and the color shift of large viewing angle are caused by an aligning deviation between the array substrate and a color filter substrate after a glass is formed as a cell. Recently, a curved TV has developed rapidly, the problem of the mismatch of a light-shading area can be solved by the BOA technology. The mismatch of the light-shading area is caused by dislocation between an upper substrate and a lower substrate. Also, problems such as the reduction of transmittance, a color shift, and the like can be avoided by the BOA technology, and the reduction of transmittance and the color shift are caused by the curving of a panel. Therefore, the BOA technology has been paid much attention.

FIG. 1 is an existing BOA structure. Please refer to FIG. 1, which shows a profile view of a data line in a pixel electrode. In which a device layer 11 is disposed on a glass substrate 10. The structure of the device layer 11 is a common TFT process, such as a-Si, IGZO, LTPS, and the like. In FIG. 1, there is an inorganic insulating layer 13 on the data line 12. The inorganic insulating layer 13 can be made of SiNx or SiO₂. An organic insulating layer 14 (PFA), a transparent electrode layer 15 (e.g., indium tin oxide, ITO), and a black matrix 16 (BM) are disposed on the inorganic insulating layer 13. In the existing BOA structure, the upper surface of the black matrix 16 thereof protrudes the upper surface of the transparent electrode layer 15 to form a convex structure. A poor liquid crystal alignment is caused by the convex structure, and the formation of the black matrix 16 needs to increase masks, and thus disadvantages to simplification of process.

### SUMMARY OF THE INVENTION

A technical problem solved by the present invention is that an LCD panel and manufacturing method thereof are provided. The present invention is able to prevent a poor liquid crystal (LC) alignment caused by a convex structure, as well as provide a simple manufacturing process.

To overcome the above-mentioned disadvantages, the present invention provides an LCD panel including a substrate, a device layer disposed on the substrate, a data line disposed on the surface of the device layer, and an organic insulating layer disposed on the surface of the device layer and/or the surface of the data line. The organic insulating layer has a groove corresponding to the data line. The width of the groove is greater than the width of the data line. A black matrix is disposed in the groove. The surface of the black matrix and the surface of the organic insulating layer are on the same plane. The LCD panel further includes an inorganic insulating layer and a color filter layer. The inorganic insulating layer is disposed on the surface of the device layer and is covered on the data line. The organic insulating layer is disposed on the surface of the inorganic insulating layer. The color filter layer is disposed between the inorganic insulating layer and the organic insulating layer. A common electrode is disposed on the surface of the organic insulating layer.

The present invention further provides an LCD panel including a substrate, a device layer disposed on the substrate, a data line disposed on the surface of the device layer, and an organic insulating layer disposed on the surface of the device layer and/or the surface of the data line. The organic insulating layer has a groove corresponding to the data line. A black matrix is disposed in the groove. The surface of the black matrix and the surface of the organic insulating layer are on the same plane.

Further, the LCD panel also includes a color filter layer. The color filter layer is disposed on the surface of the device layer and is covered on the data line. The organic insulating layer is disposed on the surface of the color filter layer.

Further, the LCD panel also includes an inorganic insulating layer. The inorganic insulating layer is disposed on the surface of the device layer and is covered on the data line. The organic insulating layer is disposed on the surface of the inorganic insulating layer.

Further, the LCD panel also includes a color filter layer. The color filter layer is disposed between the inorganic insulating layer and the organic insulating layer.

Further, a common electrode is disposed on the surface of the organic insulating layer.

Further, the width of the groove is greater than the width of the data line.

Further, the device layer is a thin film transistor layer.

The present invention further provides a method for manufacturing an LCD panel, and the method includes the following steps of: (a) providing a substrate, and forming sequentially a device layer, a data line, and an organic insulating layer onto the substrate, wherein the organic insulating layer is disposed on the surface of the device layer and/or the surface of the data line; (b) forming a groove onto the organic insulating layer, wherein the groove corresponds to the data line; (c) forming a black matrix into the groove and onto the surface of the organic insulating layer; and (d) removing the black matrix on the surface of the organic insulating layer, so that the surface of the black matrix in the groove and the surface of the organic insulating layer being on the same plane.

Further, in step (d), the black matrix having a certain thickness is removed by a dry etching method or a positive black matrix photoresist mask method, so that the surface of the black matrix in the groove and the surface of the organic insulating layer are on the same plane.

Further, in step (d), the black matrix on the surface of the organic insulating layer is removed by an over etching method to avoid the black matrix remaining on the surface of the organic insulating layer.

The present invention has the following advantages. A convex structure formed by the black matrix on a glass substrate is removed to prevent a poor liquid crystal alignment caused by the convex structure. The mask of the black matrix is saved, thus the number of masks for production use is reduced, and a simple manufacturing process is provided.

### BRIEF DESCRIPTION OF THE DRAWINGS

FIG. 1 is a schematic view of a structure of an existing BOA type LCD panel;

FIG. 2 is a schematic view of a structure of an LCD panel according to a first specific embodiment of the present invention;

FIG. 3 is a schematic view of a structure of an LCD panel according to a second specific embodiment of the present invention;

FIG. 4 is a schematic view of a structure of an LCD panel according to a third specific embodiment of the present invention;

FIG. 5 is a schematic view of a structure of an LCD panel according to a fourth specific embodiment of the present invention;

FIG. 6 is a flow chart of a method according to the present invention for manufacturing an LCD panel; and

FIGS. 7A to 7E are flow charts of a method according to the present invention for manufacturing an LCD panel.

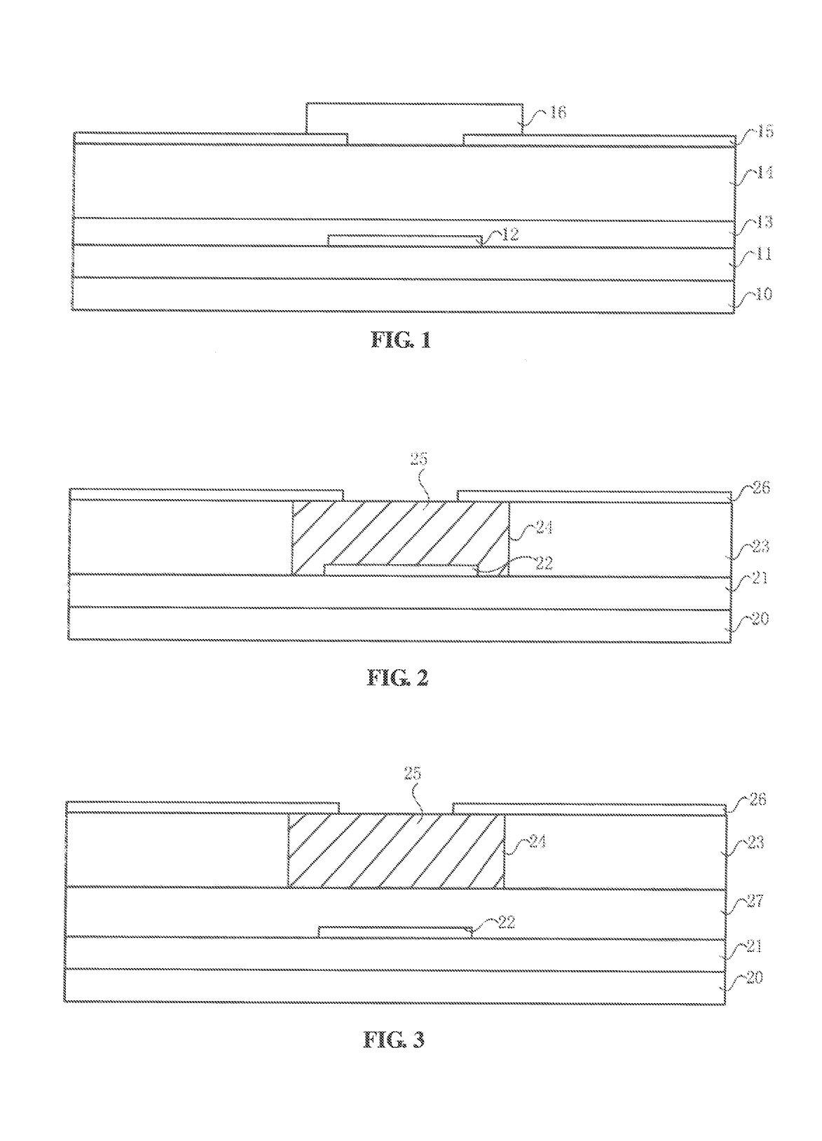

### DETAILED DESCRIPTION OF THE PREFERRED EMBODIMENTS

The specific embodiment of an LCD panel and manufacturing method thereof provided by the present invention will now be described with reference to annexed drawings.

Please refer to FIG. 2. An LCD panel according to the present invention includes a substrate 20, a device layer 21 disposed on the substrate 20, a data line 22 disposed on the surface of the device layer 21, and an organic insulating layer 23 disposed on the surface of the device layer 21 and/or the surface of the data line 22.

The organic insulating layer 23 has a groove 24 corresponding to the data line 22. In the first specific embodiment of the present invention, the organic insulating layer 23 is disposed on the surface of the device layer 21, and the data line 22 is disposed in the groove 24.

A black matrix 25 is disposed in the groove 24, and is covered on the data line 22. Preferably, the width of the groove 24 is greater than the width of the data line 22. The surface of the black matrix 25 and the surface of the organic insulating layer 23 are on the same plane, so that a convex structure formed by the black matrix 25 is not formed on the surface of the organic insulating layer 23, thereby preventing a poor liquid crystal alignment caused by the convex structure.

Further, a common electrode 26 is disposed on the surface of the organic insulating layer 23. The common electrode 26 can be a transparent electrode such as an ITO electrode. The structure of the device layer 21 is a common TFT process, such as a-Si, IGZO, LTPS, and the like. The substrate 20 can be a glass substrate.

Please refer to FIG. 3. In the second specific embodiment of an LCD panel according to the present invention, the LCD panel further includes a color filter layer 27. The color filter layer 27 is disposed on the surface of the device layer 21 and is covered on the data line 22. The organic insulating layer 23 is disposed on the surface of the color filter layer 27. The structure of the color filter layer 27 is a conventional structure in the art. One having ordinary skill in the art can obtain the structure based on prior art, and therefore it will not be redundantly stated herein.

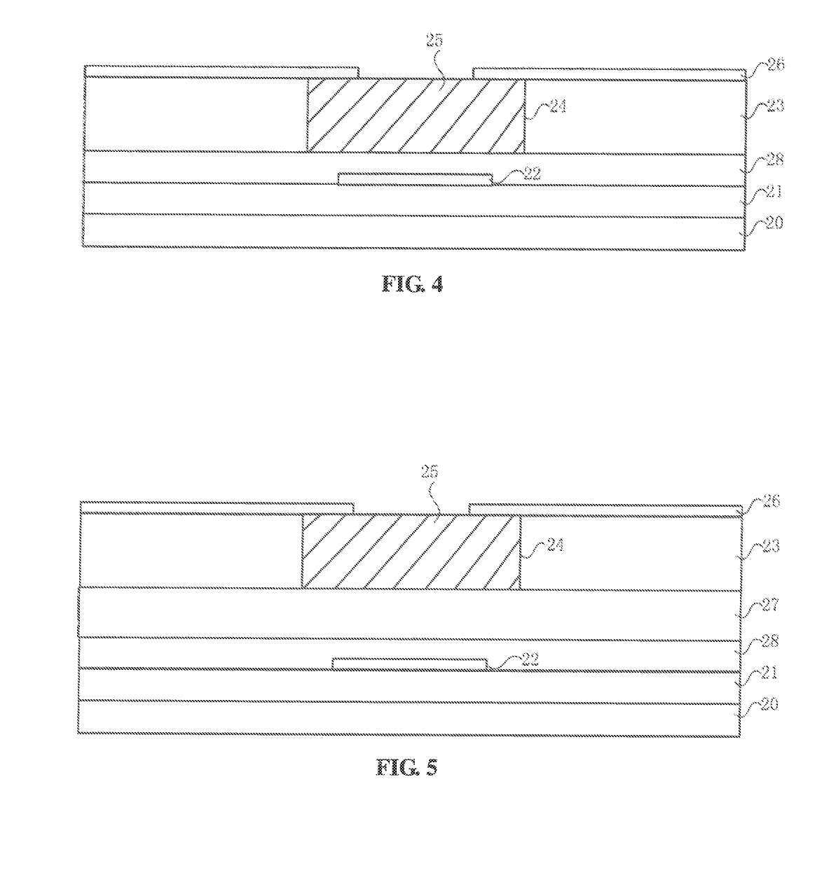

Please refer to FIG. 4. In the third specific embodiment of an LCD panel according to the present invention, the LCD panel further includes an inorganic insulating layer 28. The inorganic insulating layer 28 is disposed on the surface of the device layer 21 and is covered on the data line 22. The organic insulating layer 23 is disposed on the surface of the inorganic insulating layer 28. The inorganic insulating layer 28 can be made of SiNx or SiO₂.

Please refer to FIG. 5. In the fourth specific embodiment of an LCD panel according to the present invention, the LCD panel includes a color filter layer 27 and an inorganic insulating layer 28. The color filter layer 27 is disposed between the inorganic insulating layer 28 and the organic insulating layer 23.

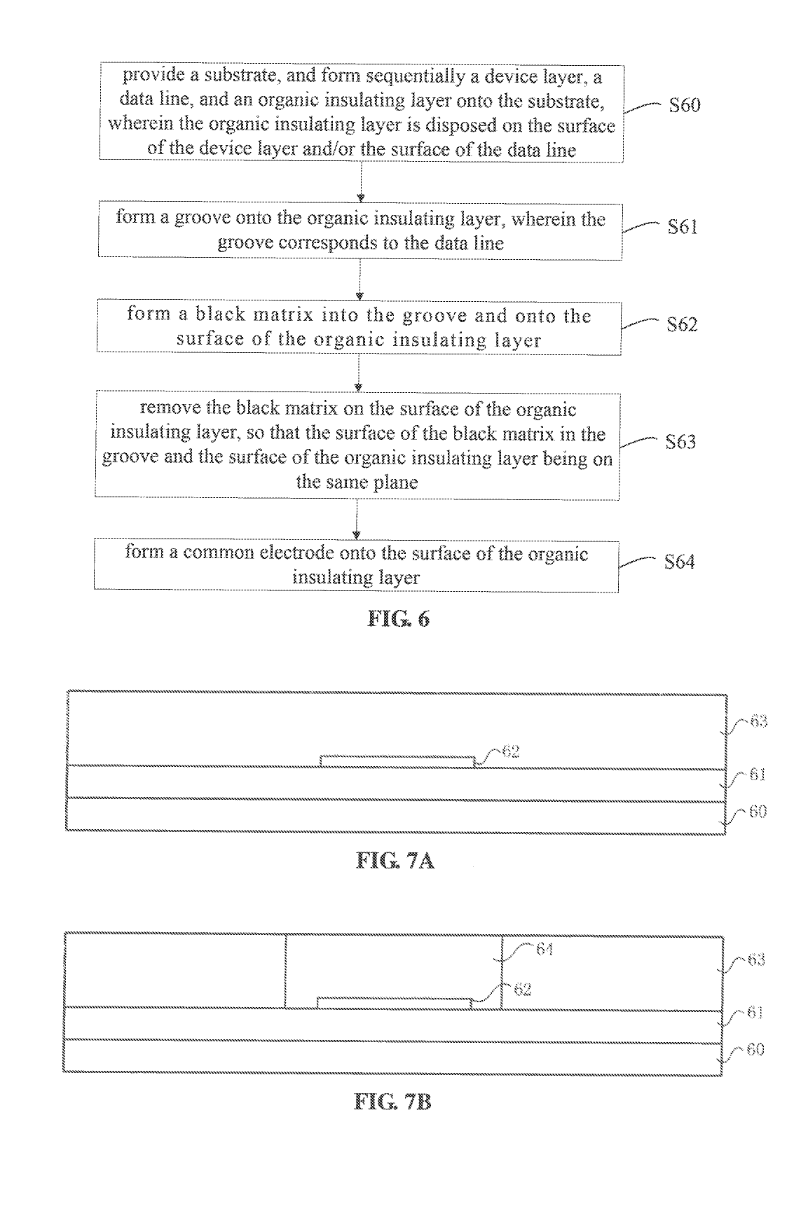

The present invention further provides a method for manufacturing an LCD panel (please refer to FIG. 6), and the method includes the following steps (S60-S63).

In step S60, a substrate is provided, a device layer, a data line, and an organic insulating layer are sequentially formed on the substrate, and the organic insulating layer is disposed on the surface of the device layer and/or the surface of the data line. In step S61, a groove is formed on the organic insulating layer, and the groove corresponds to the data line. In step S62, a black matrix is formed in the groove and is formed on the surface of the organic insulating layer. In step S63, the black matrix on the surface of the organic insulating layer is removed, so that the surface of the black matrix in the groove and the surface of the organic insulating layer are on the same plane.

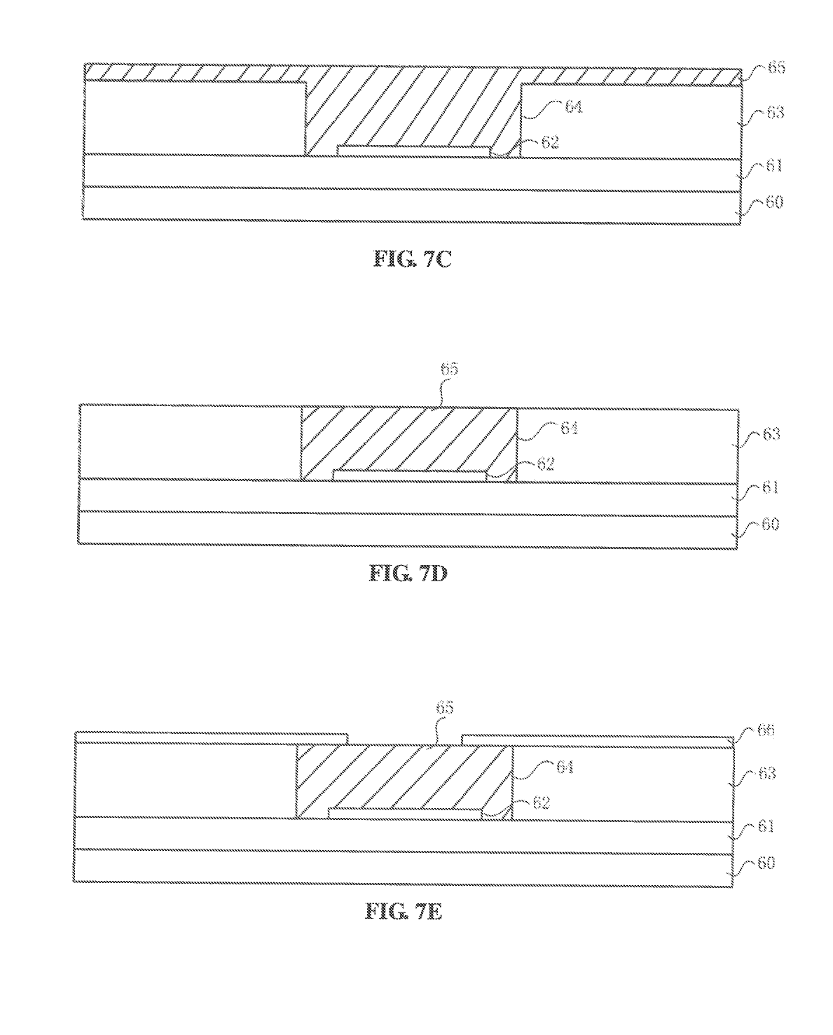

FIGS. 7A to 7E are flow charts of a method according to the present invention for manufacturing an LCD panel.

Please refer to step S60 and FIG. 7A. A substrate 60 is provided. A device layer 61, a data line 62, and an organic insulating layer 63 are sequentially formed on the substrate 60, and the organic insulating layer 63 is disposed on the surface of the device layer 61 and/or the surface of the data line 62. In the specific embodiment, the organic insulating layer 63 is disposed on the surface of the device layer 61 and is covered on the data line 62.

In other specific embodiments, the LCD panel further includes an inorganic insulating layer and/or a color filter layer (not shown in the figure). The inorganic insulating layer and/or the color filter layer is/are disposed on the surface of the device layer 61 and is/are covered on the data line 62. The organic insulating layer 63 is disposed on the surface of the inorganic insulating layer and/or the color filter layer.

Please refer to step S61 and FIG. 7B. A groove 64 is formed on the organic insulating layer 63. The groove 64 corresponds to the data line 62. In the specific embodiment, the data line 62 is disposed in the groove 64 after the formation of the groove 64, due to the organic insulating layer 63 is covered on the data line 62. One having ordinary skill in the art can obtain a method for forming the groove 64 based on prior art.

Please refer to step S62 and FIG. 7C. A black matrix 65 is formed in the groove 64 and is formed on the surface of the organic insulating layer 63. The black matrix 65 can be formed by a method known by one having ordinary skill in the art, such as deposition and the like. The black matrix 65 located on the groove 64 is thicker and the black matrix 65 on the organic insulating layer 63 (not located on the groove 64) is thinner, due to the existence of the groove 64.

Please refer to step S63 and FIG. 7D. The black matrix 65 on the surface of the organic insulating layer 63 is removed, so that the surface of the black matrix 65 in the groove 64 and the surface of the organic insulating layer 63 are on the same plane.

In the step, the black matrix 65 having a certain thickness can be removed by a dry etching method, thereby removing the black matrix 65 on the surface of the organic insulating layer 63. Further, the black matrix 65 located on the groove 64 is over-etched in order to prevent the black matrix 65 remaining on the surface of the organic insulating layer 63. Therefore, ideally, the surface of the black matrix 65 in the groove 64 and the surface of the organic insulating layer 63 are on the same plane. Actually, the surface of the black matrix 65 in the groove 64 is slightly lower than the surface of the organic insulating layer 63.

In the step, the black matrix 65 can also be removed by a positive black matrix photoresist mask method. The black matrix 65 is first irradiated by a specific dose of a UV light, so that the upper layer (i.e., the surface layer) of the black matrix 65 is sensitized, and the inside of the black matrix 65 in the groove 64 is not sensitized. Then, the upper layer of the black matrix 65 is removed, thereby leaving the black matrix 65 in the groove 64.

Further, there is step S64 after step S63. In step S64, a common electrode 66 is formed on the surface of the organic insulating layer 63.

As mentioned above, in the LCD panel provided by the present invention, the convex structure formed by the black matrix on the glass substrate is removed by disposing the black matrix of the LCD panel onto the organic insulating layer and into the groove which is pre-formed, thereby preventing a poor liquid crystal alignment caused by the convex structure, as well as saving the mask of the black matrix, and thus the number of masks for production use is reduced. In the method for manufacturing the LCD panel of the present invention, the groove is pre-formed on the organic insulating layer, and the black matrix is formed in the groove, thereby the convex structure formed by the black matrix on the glass substrate is removed to prevent a poor liquid crystal alignment caused by the convex structure; the mask of the black matrix is saved, and thus the number of masks for production use is reduced.

The above are exemplary embodiments of the present disclosure. It should be noted that a number of improvements and modifications may be made by those of ordinary skill in the art without departing from the principles of the present disclosure, and should be considered as falling within the scope of the disclosure.

What is claimed is:

1. A liquid crystal display panel, comprising a substrate, a device layer disposed on the substrate, a data line disposed on a surface of the device layer, and an organic insulating layer disposed on the surface of the device layer and/or a surface of the data line, wherein the organic insulating layer has a groove corresponding to the data line, a width of the groove is greater than a width of the data line, a black matrix is disposed in the groove, a surface of the black matrix and a surface of the organic insulating layer are on the same plane, the liquid crystal display panel further comprises an inorganic insulating layer and a color filter layer, the inorganic insulating layer is disposed on the surface of the device layer and is covered on the data line, the organic insulating layer is disposed on a surface of the inorganic insulating layer, the color filter layer is disposed between the inorganic insulating layer and the organic insulating layer, and a common electrode is disposed on the surface of the organic insulating layer.

2. The liquid crystal display panel of claim 1, wherein the device layer is a thin film transistor layer.

3. A liquid crystal display panel, comprising a substrate, a device layer disposed on the substrate, a data line disposed on a surface of the device layer, and an organic insulating layer disposed on the surface of the device layer and/or a surface of the data line, wherein the organic insulating layer has a groove corresponding to the data line, a black matrix is disposed in the groove, and a surface of the black matrix and a surface of the organic insulating layer are on the same plane.

4. The liquid crystal display panel of claim 3, further comprising a color filter layer, wherein the color filter layer is disposed on the surface of the device layer and is covered on the data line, and the organic insulating layer is disposed on a surface of the color filter layer.

5. The liquid crystal display panel of claim 3, further comprising an inorganic insulating layer, wherein the inorganic insulating layer is disposed on the surface of the device layer and is covered on the data line, and the organic insulating layer is disposed on a surface of the inorganic insulating layer.

6. The liquid crystal display panel of claim 5, further comprising a color filter layer, wherein the color filter layer is disposed between the inorganic insulating layer and the organic insulating layer.

7. The liquid crystal display panel of claim 3, wherein a common electrode is disposed on the surface of the organic insulating layer.

8. The liquid crystal display panel of claim 3, wherein a width of the groove is greater than a width of the data line.

9. The liquid crystal display panel of claim 3, wherein the device layer is a thin film transistor layer.

10. A method for manufacturing a liquid crystal display panel, comprising the following steps of:
(a) providing a substrate, and forming sequentially a device layer, a data line, and an organic insulating layer onto the substrate, wherein the organic insulating layer is disposed on a surface of the device layer and/or a surface of the data line;
(b) forming a groove onto the organic insulating layer, wherein the groove corresponds to the data line;
(c) forming a black matrix into the groove and onto a surface of the organic insulating layer, and
(d) removing the black matrix on the surface of the organic insulating layer, so that a surface of the black matrix in the groove and the surface of the organic insulating layer being on the same plane.

11. The method of claim 10, wherein in step (d), the black matrix having a certain thickness is removed by a dry etching method or a positive black matrix photoresist mask method, so that the surface of the black matrix in the groove and the surface of the organic insulating layer are on the same plane.

12. The method of claim 10, wherein in step (d), the black matrix on the surface of the organic insulating layer is removed by an over etching method to avoid the black matrix remaining on the surface of the organic insulating layer.
